(19) United States
(12) Patent Application Publication
(10) Pub. No.: US 2026/0145915 A1
(43) Pub. Date: May 28, 2026

(54) SLINGING OPERATION ASSISTANCE SYSTEM, SLINGING OPERATION ASSISTANCE METHOD, AND PROGRAM FOR WORK MACHINE

(71) Applicant: SUMITOMO HEAVY INDUSTRIES, LTD., Tokyo (JP)

(72) Inventor: Yasuhiro YAMAMOTO, Kanagawa (JP)

(21) Appl. No.: 19/396,971

(22) Filed: Nov. 21, 2025

(30) Foreign Application Priority Data
Nov. 26, 2024 (JP) 2024-205295

(51) Int. Cl. B66C 13/08; B66C 13/46; B66C 15/06

(52) U.S. Cl. CPC B66C 13/08; B66C 13/46; B66C 15/065

(57) ABSTRACT

A slinging operation assistance system that assists a slinging operation for a suspended load includes an image-capturing device including a first memory and a first processor coupled to the first memory and configured to capture an image of the suspended load; a computing device including a second memory and a second processor coupled to the second memory and configured to identify a center-of-gravity position of the suspended load based on the captured image taken by the image-capturing device; and an output device including a third memory and a third processor coupled to the third memory and configured to notify a slinging worker of the center-of-gravity position of the suspended load identified by the computing device or a position of a hook for hoisting the suspended load, the position of the hook being calculated based on the center-of-gravity position of the suspended load.

### CROSS-REFERENCE TO RELATED APPLICATIONS

This application is based upon and claims priority to Japanese Patent Application No. 2024-205295, filed on Nov. 26, 2024, the entire contents of which are incorporated herein by reference.

### BACKGROUND

### 1. Technical Field

The present disclosure relates to a slinging operation assistance system, a slinging operation assistance method, and a program for a work machine.

### 2. Description of Related Art

In the related art, an anti-sway slinging guide system capable of reducing the swing of a suspended load lifted by a crane is known. This system is configured to reduce the swing of a suspended load caused by deflection of the boom that occurs when the load is lifted. Specifically, the system is configured to take into account deflection of a boom that occurs when a load is lifted, and to present, to an operator of a crane, an anti-sway slinging position in which the center of mass (center of gravity) of the suspended load is located farther from the crane than a position directly below a tip of the boom at the start of lifting of the load.

However, the above-described system is not configured to present useful information to a slinging worker. Accordingly, the system cannot provide any assistance for a slinging operation performed by the slinging worker.

### SUMMARY

A slinging operation assistance system that assists a slinging operation for a suspended load includes: an image-capturing device including a first memory and a first processor coupled to the first memory and configured to capture an image of the suspended load; a computing device including a second memory and a second processor coupled to the second memory and configured to identify a center-of-gravity position of the suspended load based on the captured image taken by the image-capturing device; and an output device including a third memory and a third processor coupled to the third memory and configured to notify a slinging worker of the center-of-gravity position of the suspended load identified by the computing device or a position of a hook for hoisting the suspended load, the position of the hook being calculated based on the center-of-gravity position of the suspended load.

### BRIEF DESCRIPTION OF THE DRAWINGS

FIG. 1 is a schematic diagram illustrating a configuration example of a slinging operation assistance system according to an embodiment of the present disclosure;

FIG. 2 is a block diagram illustrating the configuration example of the slinging operation assistance system illustrated in FIG. 1;

FIG. 3 is a flowchart illustrating an example of a flow of slinging operation assistance processing;

FIG. 4 is a diagram illustrating an example of a work site where a slinging operation is performed;

FIG. 5 is a diagram illustrating another example of a work site where a slinging operation is performed;

FIG. 6 is a diagram illustrating an example of an image captured by a camera attached to a tip of a boom;

FIG. 7 is a view illustrating an example of a state of a suspended load before the suspended load is lifted off the ground;

FIG. 8 is a flowchart illustrating an example of a flow of center-of-gravity position reidentification processing; and

FIG. 9 is a flowchart illustrating another example of the flow of center-of-gravity position reidentification processing.

### DETAILED DESCRIPTION

Hereinafter, embodiments of the present disclosure will be described with reference to the drawings. The embodiments described below are not intended to limit the invention but are intended to illustrate the invention, and all features and combinations thereof described as the embodiments are not necessarily essential to the invention. In the drawings, the same or corresponding components are denoted by the same or corresponding reference signs, and the description thereof may be omitted.

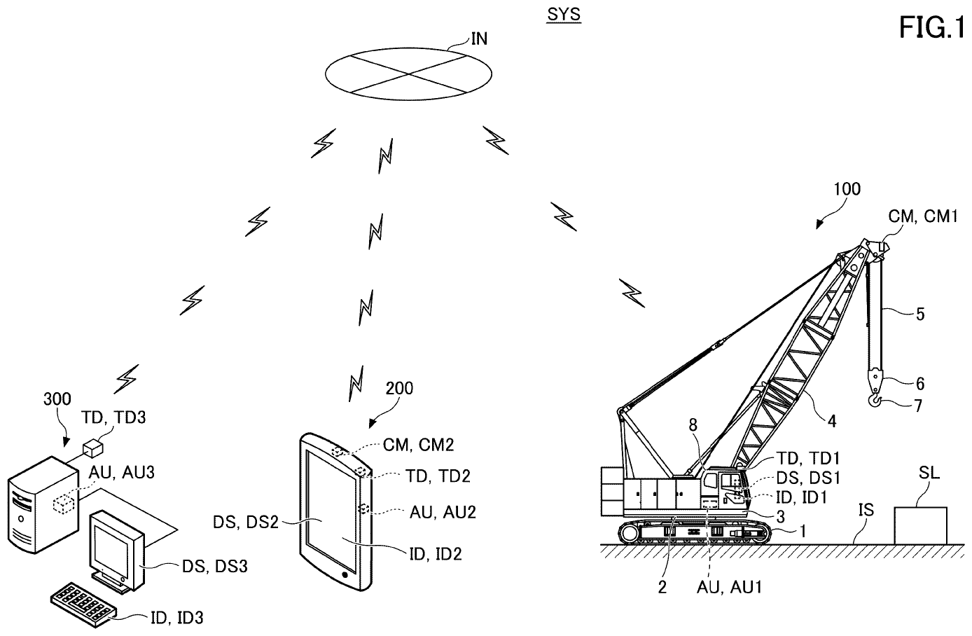

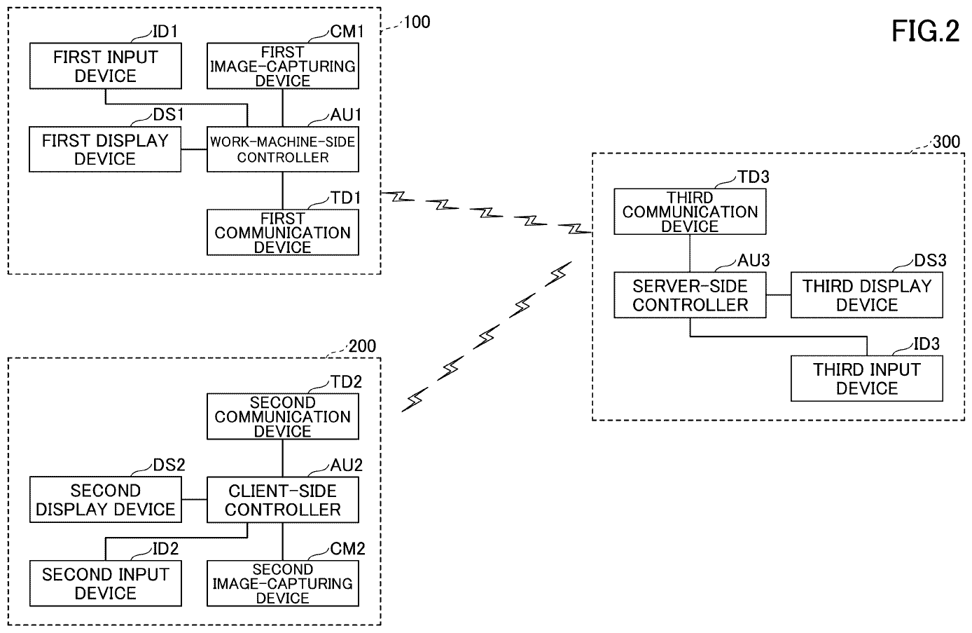

First, a slinging operation assistance system SYS, which is a system for a work machine according to an embodiment of the present disclosure, will be described with reference to FIGS. 1 and 2. FIG. 1 is a schematic diagram illustrating a configuration example of the slinging operation assistance system SYS. FIG. 2 is a block diagram illustrating the configuration example of the slinging operation assistance system SYS.

The slinging operation assistance system SYS is a system that assists a slinging operation performed by a slinging worker. In the illustrated example, the slinging operation assistance system SYS mainly includes a work machine 100, an assistance device 200, and a management device 300. The work machine 100, the assistance device 200, and the management device 300 each include a communication device TD, and are directly or indirectly connected to one another via an information communication network IN such as a mobile phone communication network, a satellite communication network, or a short-range wireless communication network. Each of the work machine 100, the assistance device 200, and the management device 300 included in the slinging operation assistance system SYS may be a single apparatus or a plurality of apparatuses. In the illustrated example, the slinging operation assistance system SYS includes one work machine 100, one assistance device 200, and one management device 300.

In the illustrated example, the work machine 100 is a mobile crane and includes an upper structure 3 rotatably mounted on a crawler undercarriage 1 via a slewing mechanism 2. A boom 4 is attached to the upper structure 3. A wire rope 5 hangs down from a tip of the boom 4, and a hook 7 is suspended from the wire rope 5 via a hook bracket 6. The hook bracket 6 has a pulley (not illustrated) inside, over which the wire rope 5 passes.

An image-capturing device CM (first image-capturing device CM1) is attached to the tip of the boom 4. In the illustrated example, the first image-capturing device CM1 is a monocular camera and is disposed to capture an image of a space vertically below. The first image-capturing device CM1 may be, for example, a stereo camera, a red-green-blue depth (RGB-D) camera, or a light detection and ranging (LiDAR) device, which is capable of measuring a distance between the first image-capturing device CM1 and a subject.

The work machine 100 is capable of hoisting a suspended load SL by winding the wire rope 5 with a front winch (not illustrated), thereby raising the hook 7. The work machine 100 is also capable of lowering the suspended load SL by paying out the wire rope 5 with the front winch (not illustrated), thereby causing the hook 7 to descend.

The upper structure 3 is provided with a cab 8 serving as an operator's compartment and a drive source such as an engine. Moreover, the upper structure 3 is equipped with a computing device AU (a work-machine-side controller AU1), a display device DS (a first display device DS1), an input device ID (a first input device ID1), a communication device TD (a first communication device TD1), and the like. Note that the drive source may be an electric motor that is driven by a battery or an external power supply. The first input device ID1 may be a touch panel, a hardware button, or a microphone for voice input.

The work-machine-side controller AU1 is configured to control the work machine 100. In the illustrated example, the work-machine-side controller AU1 is an example of a processing circuit that serves as a control device (computing device AU), and is implemented by a computer including a central processing unit (CPU), a random access memory (RAM), a non-volatile random access memory (NVRAM), a read-only memory (ROM), and the like. The work-machine-side controller AU1 reads out programs corresponding to respective functional elements from the ROM, loads the programs into the RAM, and causes the CPU to execute corresponding processing. However, each functional element may be implemented in hardware, or may be implemented by a combination of software and hardware.

The assistance device 200 is a device that assists a slinging operation performed by a slinging worker. In the illustrated example, the assistance device 200 is a portable client computer (e.g., a mobile terminal device such as a laptop personal computer (PC), a tablet PC, or a smartphone) carried by a slinging worker, and includes a computing device AU (a client-side controller AU2), an image-capturing device (a second image-capturing device CM2), a display device DS (a second display device DS2), an input device ID (a second input device ID2), and a communication device TD (a second communication device TD2). Note that the assistance device 200 may function as a server. The assistance device 200 may be a wearable terminal device such as extended reality (XR) goggles.

The client-side controller AU2 is configured to control the assistance device 200. In the illustrated example, the client-side controller AU2 is another example of a processing circuit that serves as a computing device AU, and is implemented by a computer including a CPU, a RAM, an NVRAM, a ROM, and the like. The client-side controller AU2 reads programs corresponding to respective functional elements from the ROM, loads the programs into the RAM, and causes the CPU to execute corresponding processes. However, each functional element may be implemented in hardware, or may be implemented by a combination of software and hardware.

In the illustrated example, the assistance device 200 is a smartphone, the second image-capturing device CM2 is a camera provided in the smartphone, the second display device DS2 is an organic electroluminescent (EL) display, and the second input device ID2 is a touch panel. Note that the second image-capturing device CM2 may be, for example, a stereo camera, an RGB-D camera, or a LiDAR device, which is capable of measuring a distance between the second image-capturing device CM2 and a subject. The second input device ID2 may be a microphone for voice input.

The management device 300 is a device that manages an operation performed by the work machine 100. In the illustrated example, the management device 300 is a server computer installed in a management center or the like located remotely from the work site (the work machine 100), and includes a computing device AU (a server-side controller AU3), a display device DS (a third display device DS3), an input device ID (a third input device ID3), and a communication device TD (a third communication device TD3). Note that the management device 300 may be a portable computer (e.g., a mobile terminal device such as a laptop PC, a table PC, or a smartphone).

In the illustrated example, the management device 300 is a desktop PC, the third display device DS3 is a liquid-crystal display, and the third input device ID3 is a keyboard and a mouse.

The server-side controller AU3 is configured to control the management device 300. In the illustrated example, the server-side controller AU3 is still another example of a processing circuit that serves as a computing device AU, and is implemented by a computer including a CPU, a RAM, an NVRAM, a ROM, and the like. The server-side controller AU3 reads out programs corresponding to respective functional elements from the ROM, loads the programs into the RAM, and causes the CPU to execute corresponding processing. However, each functional element may be implemented in hardware, or may be implemented by a combination of software and hardware.

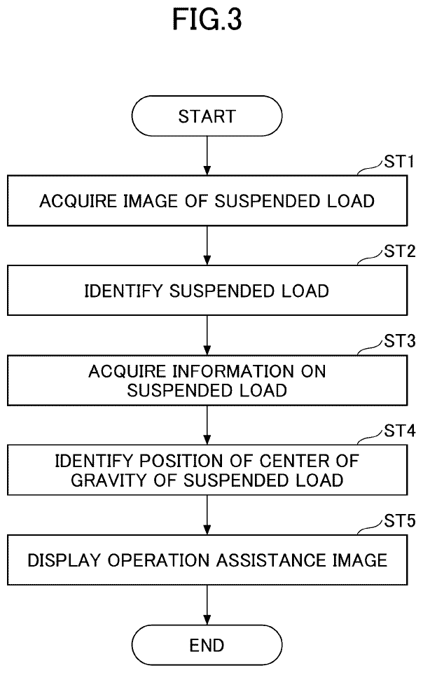

Next, an example of a processing flow in which the slinging operation assistance system SYS assists a slinging operation performed by a slinging worker (hereinafter referred to as “slinging operation assistance processing”) will be described with reference to FIG. 3. FIG. 3 is a flowchart illustrating an example of a flow of the slinging operation assistance processing. In the illustrated example, the client-side controller AU2 of the assistance device 200 starts the slinging operation assistance processing when a predetermined operation using the second input device ID2 is performed by a user of the assistance device 200. The predetermined operation is, for example, a touch on a predetermined icon. In the illustrated example, the predetermined icon is a start icon for launching a slinging operation assistance application. Note that the predetermined operation may be pressing a predetermined hardware button such as an operation assistance start button, or may be saying a predetermined keyword.

First, the client-side controller AU2 acquires an image of the suspended load SL (Step ST1). In the illustrated example, when the start icon is touched, the client-side controller AU2 displays an initial screen of the slinging operation assistance application and further displays a text message such as “Please capture the suspended load.”

After viewing this text message, a slinging worker, who is the user of the assistance device 200, captures an image of the suspended load SL by using the second image-capturing device CM2 mounted on the assistance device 200.

After acquiring the image of the suspended load SL, the client-side controller AU2 identifies the suspended load SL (Step ST2). In the illustrated example, the client-side controller AU2 identifies the suspended load SL by using a known image recognition technique. Note that the client-side controller AU2 may present a text message such as “Trace the outline of the suspended load in the image” to the slinging worker. This is to facilitate the identification of the suspended load SL.

After identifying the suspended load SL, the client-side controller AU2 acquires information on the suspended load SL (Step ST3). In the illustrated example, the client-side controller AU2 accesses the management device 300 and reads out information regarding the identified suspended load SL stored in a storage device of the management device 300. This is because, when the suspended load SL is a standardized product such as a building material, information regarding the suspended load SL is typically stored in advance in the storage device of the management device 300. The information regarding the identified suspended load SL may include the position (three-dimensional coordinates) of the center of mass (center of gravity). In this case, the three-dimensional coordinates of the center of gravity may be stored in advance, for example, as relative coordinates defined with respect to a plurality of three-dimensional coordinates on the surface of the suspended load SL. This is to enable the three-dimensional coordinates of the center of gravity to be uniquely determined when a plurality of three-dimensional coordinates on the surface of the suspended load SL are identified. Alternatively, the three-dimensional coordinates (relative coordinates) of the center of gravity may be dynamically determined based on at least one of the dimensions, material, weight, product number, or the like of the suspended load SL stored in advance.

Alternatively, the client-side controller AU2 may acquire an image of the suspended load SL captured from a different viewpoint. In this case, the client-side controller AU2 may present a text message such as “Please capture the suspended load from the left side, the right side, and the rear side of the suspended load” to the slinging worker. Note that the terms “front,” “rear,” “left,” “right,” “up,” and “down” represent directions as viewed from the slinging worker. The same applies to the following description.

After acquiring the information on the suspended load SL, the client-side controller AU2 identifies the position of the center of gravity of the suspended load SL (Step ST4). In the illustrated example, the client-side controller AU2 associates each of the plurality of three-dimensional coordinates on the surface of the suspended load SL received from the management device 300 with a corresponding point on the image of the suspended load SL. Then, the client-side controller AU2 associates the three-dimensional coordinates of the center of gravity of the suspended load SL received from the management device 300 with one corresponding point (two-dimensional coordinates) on the image of the suspended load SL.

Alternatively, the client-side controller AU2 may identify the shape of the suspended load SL from the acquired image of the suspended load SL, and identify the position of the center of gravity of the suspended load SL from the identified shape. Specifically, for example, the client-side controller AU2 may generate a three-dimensional model of the suspended load SL by using a plurality of images obtained by capturing images of the suspended load SL from multiple viewpoints and a known three-dimensional reconstruction technique. The three-dimensional reconstruction technique is a technique for estimating three-dimensional information from two-dimensional images captured by the image-capturing device CM, and includes, for example, a photogrammetry technique or a Neural Radiance Fields (NeRF) technique. Then, the client-side controller AU2 may identify one point (two-dimensional coordinates) on the image of the suspended load SL corresponding to the center of gravity of the suspended load SL based on the three-dimensional model.

To identify the position of the center of gravity of the suspended load SL from the images of the suspended load SL or the three-dimensional model of the suspended load SL, for example, a machine learning technique is used. That is, the client-side controller AU2 can use a trained model generated by analyzing (training on) a large number of images or three-dimensional models, thereby outputting the position of the center of gravity based on the images of the suspended load SL or the three-dimensional models of the suspended load SL that have been input. The machine learning model is, for example, a neural network model trained using backpropagation.

After identifying the position of the center of gravity of the suspended load SL, the client-side controller AU2 displays an operation assistance image (Step ST5). In the illustrated example, the client-side controller AU2 displays a graphic image (e.g., a circular image) representing the position of the center of gravity of the suspended load SL as the operation assistance image (center-of-gravity image) superimposed on the image of the suspended load SL. The image of the suspended load SL may be a still image or a moving image that is currently being captured by the second image-capturing device CM2. When the image of the suspended load SL is a moving image, the display position of the center-of-gravity image is changed in accordance with the movement of the slinging worker carrying the assistance device 200, that is, in accordance with the motion of the image of the suspended load SL displayed on the second display device DS2.

The slinging worker can recognize the position of the center of gravity of the suspended load SL by viewing the center-of-gravity image superimposed on the image of the suspended load SL displayed on the second display device DS2. Therefore, the slinging worker can guide the hook 7 to a position directly above the center of gravity of the suspended load SL.

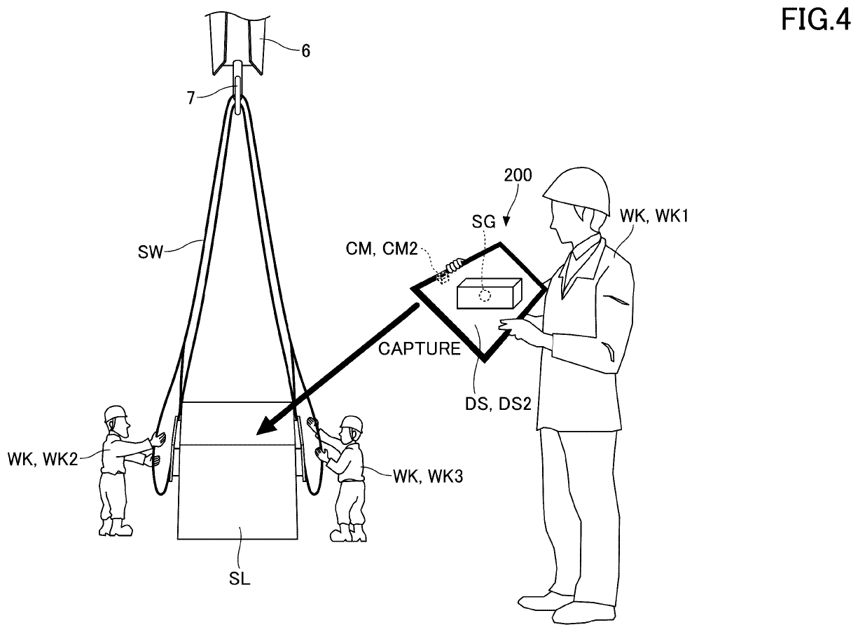

Next, a method will be described with reference to FIG. 4, in which the slinging worker WK checks the position of the center of gravity of the suspended load SL by using the slinging operation assistance system SYS. FIG. 4 is a diagram illustrating an example of a work site where a slinging operation is performed.

Specifically, at the work site illustrated in FIG. 4, a second slinging worker WK2 and a third slinging worker WK3 are attaching a sling wire SW to the suspended load SL, while a first slinging worker WK1 is checking the position of the center of gravity of the suspended load SL by using the assistance device 200. Note that the first slinging worker WK1 carries a tablet PC as the assistance device 200.

More specifically, the first slinging worker WK1 is capturing an image of the suspended load SL with the second image-capturing device CM2 of the assistance device 200. The image captured (captured image) by the second image-capturing device CM2 is transmitted to the management device 300. The management device 300 applies a known image recognition technique to the image received from the assistance device 200 to identify what kind of object the suspended load SL is. In a case where details such as the dimensions, the weight, or the center-of-gravity position of a target object (the suspended load SL) of the crane operation are already registered, the management device 300 can identify the position of the center of gravity of the suspended load SL by identifying which of the registered items the suspended load SL shown in the captured image is. The registered items include, for example, containers, wall materials, and floor materials.

Alternatively, the management device 300 may apply a known image recognition technique to one or more captured images received from the assistance device 200, analyze the three-dimensional shape of the suspended load SL, and identify the position of the center of gravity of the suspended load SL.

Thereafter, the information (center-of-gravity position information) regarding the position of the center of gravity of the suspended load SL identified by the management device 300 is transmitted to the assistance device 200. The assistance device 200 superimposes and displays an operation assistance image SG at an appropriate position on the image displayed on the second display device DS2 (on the image being captured by the second image-capturing device CM2) based on the received center-of-gravity position information. The operation assistance image SG is, for example, a graphic image indicating the position of the center of gravity of the suspended load SL. Note that the operation assistance image SG may be a graphic image indicating a position where the hook 7 is to be positioned (typically, a position directly above the center of gravity of the suspended load SL).

The first slinging worker WK1 can check the position of the center of gravity of the suspended load SL by viewing the operation assistance image SG displayed on the second display device DS2. Therefore, for example, the first slinging worker WK1 can give an instruction to the operator of the work machine 100 through the communication device TD or the like so as to move the hook 7 to a position directly above the center of gravity of the suspended load SL. Specifically, the first slinging worker WK1 can guide the hook 7 to a position directly above the center of gravity of the suspended load SL by notifying the operator of the work machine 100 of information, such as “Move the hook 7 by 30 cm to the right and 30 cm to the rear.” This information may be voice information or text information. Note that the slinging operation assistance system SYS may automatically give substantially the same instruction to the operator of the work machine 100 independently of an instruction from the first slinging worker WK1. The slinging operation assistance system SYS may be configured such that voice communication is always available between the slinging worker WK and the operator who operates the work machine 100. That is, the work machine 100 and the assistance device 200 may each include devices necessary for voice communication, such as a microphone and a speaker.

In the above example, the server-side controller AU3 of the management device 300 identifies what kind of object the suspended load SL is and identifies the position of the center of gravity of the suspended load SL. However, at least one of the identification processes may be executed by the work-machine-side controller AU1 of the work machine 100 or may be executed by the client-side controller AU2 of the assistance device 200.

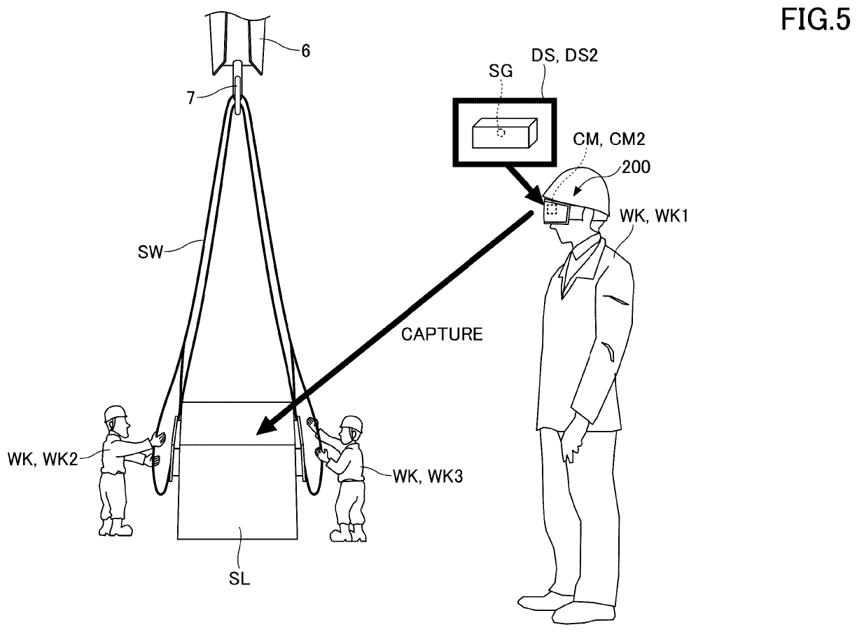

Next, another method will be described with reference to FIG. 5, in which the first slinging worker WK1 checks the position of the center of gravity of the suspended load SL by using the slinging operation assistance system SYS. FIG. 5 is a diagram illustrating another example of a work site where a slinging operation is performed. The first slinging worker WK1 at the work site illustrated in FIG. 5 wears augmented reality (AR) glasses serving as the assistance device 200, which is different from the first slinging worker WK1 at the work site illustrated in FIG. 4. Other than that, the method of checking the position of the center of gravity of the suspended load SL by the first slinging worker WK1 at the work site illustrated in FIG. 5 is the same as the method of checking the position of the center of gravity of the suspended load SL by the first slinging worker WK1 at the work site illustrated in FIG. 4. Therefore, hereinafter, redundant description will be omitted, and the difference will be described in detail.

Specifically, the AR glasses serving as the assistance device 200 include a camera provided to capture an image of a front view and a pair of small displays provided respectively for the eyes of the first slinging worker WK1. Then, the AR glasses superimpose an operation assistance image SG at an appropriate position on an image displayed on the second display device DS2 (the pair of small displays), that is, on an image being captured by the second image-capturing device CM2 (the camera), based on center-of-gravity position information received from the management device 300. The operation assistance image SG is a graphic image indicating the position of the center of gravity of the suspended load SL.

The first slinging worker WK1 can check the position of the center of gravity of the suspended load SL by viewing the operation assistance image SG displayed on the second display device DS2. That is, with this configuration, the first slinging worker WK1 can check the position of the center of gravity of the suspended load SL without taking his or her eyes off the suspended load SL and without having both hands occupied by the assistance device 200.

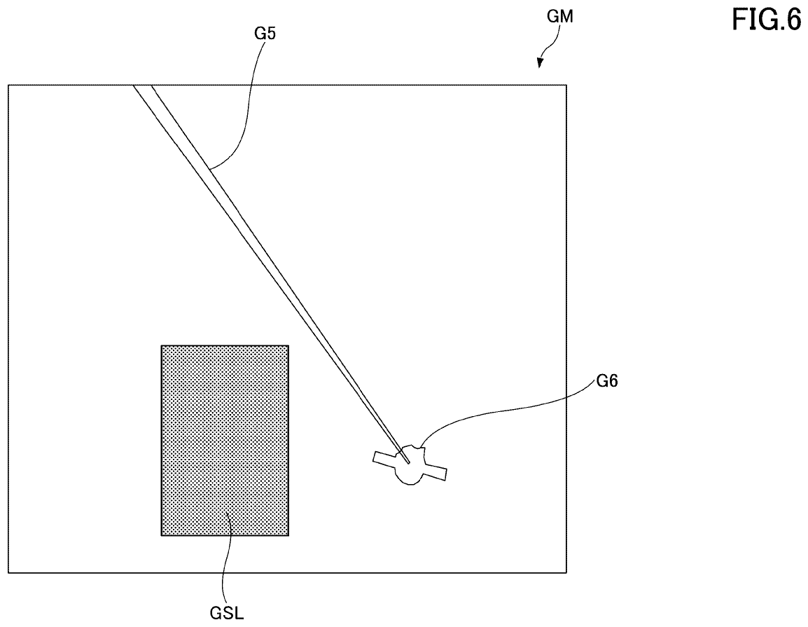

Next, with reference to FIG. 6, another example of a method by which the management device 300 identifies the suspended load SL or the position of the center of gravity thereof will be described. FIG. 6 is a diagram illustrating an example of an image GM captured by the first image-capturing device CM1 attached to the tip of the boom 4 of the work machine 100. The first image-capturing device CM1 is attached to the tip of the boom 4 so as to capture an image of a vertically downward view and acquire an image of the hook 7 and its surroundings.

Specifically, the image GM is an image captured by the first image-capturing device CM1 located above the suspended load SL, and includes an image G5 of the wire rope 5, an image G6 of the hook bracket 6, and an image GSL of the suspended load SL.

The management device 300 is configured to use not only an image (an image captured by the second image-capturing device CM2) received from the assistance device 200, but also the image GM to identify what kind of object the suspended load SL is, and further to identify the position of the center of gravity of the suspended load SL.

With this configuration, the management device 300 can identify the type of suspended load SL with higher accuracy than in a case where the type of suspended load SL is identified based only on the image received from the assistance device 200 (the image captured by the second image-capturing device CM2). This is because an image (an image of the suspended load SL captured from directly above), which cannot be captured by the second image-capturing device CM2 mounted on the assistance device 200 carried by the first slinging worker WK1, can be additionally used. The same applies to the accuracy of identifying the position of the center of gravity of the suspended load SL.

However, the management device 300 may be configured to identify what the suspended load SL is and may further be configured to identify the position of the center of gravity of the suspended load SL, based only on an image captured by the first image-capturing device CM1. Alternatively, the management device 300 may additionally or alternatively use an image captured by a different image-capturing device other than the first image-capturing device CM1 and the second image-capturing device CM2. That is, the management device 300 may be configured to identify what kind of the suspended load SL is and may be further configured to identify the position of the center of gravity of the suspended load SL, based on at least one of the image captured by the first image-capturing device CM1, the image captured by the second image-capturing device CM2, or the image captured by the different image-capturing device. Note that the different image-capturing device may be, for example, an image-capturing device attached to a structure such as a steel tower at a work site, or an image-capturing device attached to a flying object such as a multicopter that flies over the suspended load SL.

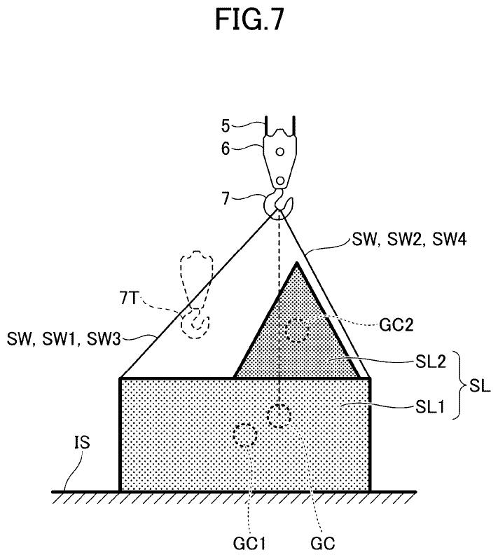

Next, with reference to FIG. 7, an effect obtained by the slinging operation assistance system SYS assisting a slinging operation performed by the slinging worker WK will be described. FIG. 7 is a diagram illustrating an example of a state of the suspended load SL before the suspended load SL is lifted off the ground. Note that lifting off the ground” of the suspended load SL refers to an operation of separating (hoisting) the suspended load SL from an installation surface IS (a ground surface on which the suspended load SL is placed). In the example illustrated in FIG. 7, the suspended load SL is a combination of a first suspended load SL1 and a second suspended load SL2, and the second suspended load SL2 is stacked on the first suspended load SL1. Four sling wires SW (a first sling wire SW1 to a fourth sling wire SW4) are hooked between the suspended load SL and the hook 7. In FIG. 7, the third sling wire SW3 is not visible behind the first sling wire SW1, and the fourth sling wire SW4 is not visible behind the second sling wire SW2. The length of the first sling wire SW1 is substantially the same as the length of the third sling wire SW3, and the length of the second sling wire SW2 is substantially the same as the length of the fourth sling wire SW4. The lengths of the first sling wire SW1 and the third sling wire SW3 are greater than the lengths of the second sling wire SW2 and the fourth sling wire SW4.

In the example illustrated in FIG. 7, the hook 7 is located directly above the combined center of gravity GC of the suspended load SL, and each of the four sling wires SW (the first sling wire SW1 to the fourth sling wire SW4) is in a slightly loosened state. This state is realized by the slinging operation assistance processing, and is hereinafter referred to as a “ready state.”

In the example illustrated in FIG. 7, the first slinging worker WK1 (see FIG. 4) can easily identify the position of the combined center of gravity GC of the suspended load SL, which is derived as a combined center of gravity of a first center of gravity GC1 and a second center of gravity GC2, by viewing the operation assistance image SG displayed on the second display device DS2. Note that the first center of gravity GC1 is the center of gravity of the first suspended load SL1, and the second center of gravity GC2 is the center of gravity of the second suspended load SL2. That is, the first slinging worker WK1 can easily identify the position of the combined center of gravity GC of the suspended load SL, which is difficult to determine from the external appearance of the suspended load SL.

Moreover, the first slinging worker WK1 who views the operation assistance image SG can estimate in advance the length of each of the four sling wires SW (the first sling wire SW1 to the fourth sling wire SW4) in the ready state. Thus, for example, the first slinging worker WK1 can notify the second slinging worker WK2 (see FIG. 4) and the third slinging worker WK3 (see FIG. 4) of the lengths of the four sling wires SW in the ready state before the four sling wires SW are hooked to the hook 7. Therefore, the slinging operation assistance system SYS can suppress the use of the sling wire SW having an inappropriate length.

Since the appropriate length of each of the four sling wires SW can be known in advance, the first slinging worker WK1 can appropriately determine a temporary position (a position different from the position (target position) in the ready state) of the hook 7 where each of the four sling wires SW can be easily hooked. FIG. 7 illustrates the hook 7 at its temporary position, which is indicated by a hook 7T in broken lines. Note that the temporary position of the hook 7 is, for example, a position reachable by the hands of the second slinging worker WK2 and the third slinging worker WK3.

Specifically, the first slinging worker WK1 can guide an operation performed by the operator of the work machine 100 through the communication device TD or the like so that the hook 7 moves to the temporary position. Note that the slinging operation assistance system SYS may be configured to display, on the display device DS, a graphic image indicating at least one of the target position or the temporary position of the hook 7 as the operation assistance image SG. In this case, the slinging operation assistance system SYS may omit displaying a graphic image indicating the center-of-gravity position of the suspended load SL.

Thereafter, the second slinging worker WK2 and the third slinging worker WK3 can hook each of the four sling wires SW to the hook 7 while the hook 7 is positioned at the temporary position. Then, after checking that each of the four sling wires SW is appropriately hooked to the hook 7, the first slinging worker WK1 can guide an operation performed by the operator of the work machine 100 through the communication device TD or the like so that the hook 7 moves to the target position.

Then, after checking that the hook 7 is positioned at the target position, the first slinging worker WK1 can instruct the operator of the work machine 100 through the communication device TD or the like to start an operation of hoisting the suspended load SL.

As a result, the work machine 100 can hoist the suspended load SL directly upward and lift the suspended load SL off the ground with little or no swinging of the suspended load SL.

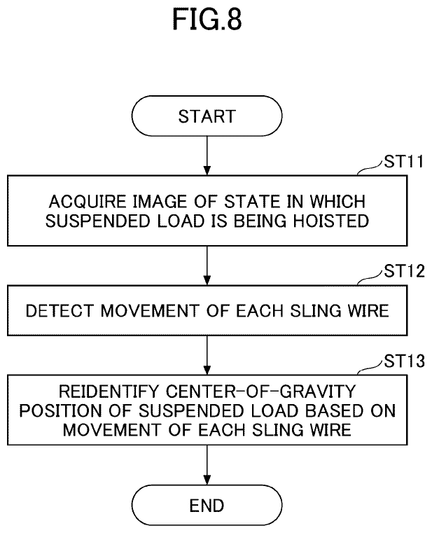

Next, an example of processing will be described with reference to FIG. 8, in which the position of the center of gravity of the suspended load SL identified in the slinging operation assistance processing is reidentified (hereinafter referred to as “center-of-gravity position reidentification processing”). FIG. 8 is a flowchart illustrating an example of a flow of the center-of-gravity position reidentification processing. In the illustrated example, the client-side controller AU2 of the assistance device 200 starts the center-of-gravity position reidentification processing when a predetermined operation using the second input device ID2 is performed by the first slinging worker WK1 (see FIG. 4). The predetermined operation is, for example, a touch on a predetermined icon.

First, the client-side controller AU2 acquires a series of images representing a state in which the suspended load SL is being hoisted (Step ST11). In the illustrated example, when a predetermined icon is touched, the client-side controller AU2 causes the second display device DS2 to display a text message such as “Please capture the suspended load.” After viewing this text message, the first slinging worker WK1 directs the second image-capturing device CM2 toward the suspended load SL and starts to capture a moving image.

The operator of the work machine 100 starts raising the hook 7 in response to an instruction from the slinging operation assistance system SYS or the first slinging worker WK1. Each of the four sling wires SW (see FIG. 3) changes from a slightly loosened state to a taut state as the hook 7 is raised.

Thereafter, the client-side controller AU2 detects a movement of each sling wire SW (Step ST12). The movement of the sling wire SW includes, for example, the amount (magnitude) of movement of the sling wire SW, the degree of tension of the sling wire SW, or the like. For example, before the suspended load SL is lifted off the ground, the client-side controller AU2 can detect, based on the series of images captured by the second image-capturing device CM2, the timing at which each of the four sling wires SW becomes taut.

Thereafter, the client-side controller AU2 reidentifies the center-of-gravity position of the suspended load SL based on the movement of each sling wire SW (Step ST13). For example, when the client-side controller AU2 determines that the time point at which the first sling wire SW1 becomes taut is delayed by a predetermined time or more relative to the time points at which the other three sling wires SW become taut, the client-side controller AU2 determines that the hook 7 is not located directly above the center-of-gravity position of the suspended load SL. In this case, the client-side controller AU2 reidentifies the center-of-gravity position by bringing the current center-of-gravity position closer to the lower end of the first sling wire SW1. Note that the determination as to whether or not the hook 7 is located directly above the center-of-gravity position of the suspended load SL may be made by using a machine learning technique.

In this case, the client-side controller AU2 may change, based on the reidentified center-of-gravity position, the display position of the operation assistance image SG (a graphic image indicating the position of the center of gravity of the suspended load SL) that is superimposed on the image of the suspended load SL.

The operator of the work machine 100 stops the raising of the hook 7 in response to an instruction from the slinging operation assistance system SYS or the first slinging worker WK1 and then lowers the hook 7 to the original target position.

Thereafter, the first slinging worker WK1 can give an instruction to the operator of the work machine 100 through the communication device TD or the like so as to move the hook 7 to a position directly above the reidentified center-of-gravity position. Note that the slinging operation assistance system SYS may automatically give substantially the same instruction to the operator of the work machine 100 independently of an instruction from the first slinging worker WK1. Alternatively, the first slinging worker WK1 may adjust the length of each of the four sling wires SW based on the reidentified center-of-gravity position.

By such center-of-gravity position reidentification processing, the slinging operation assistance system SYS can determine, even after the center-of-gravity position of the suspended load SL in the ready state has been identified, whether or not the hook 7 is located directly above the position of the center of gravity of the suspended load SL when the raising of the hook 7 is started. Therefore, even after the raising of the hook 7 is started, the slinging operation assistance system SYS can notify the first slinging worker WK1 that the hook 7 is not located directly above the position of the center of gravity of the suspended load SL. The slinging operation assistance system SYS can also present the reidentified center-of-gravity position to the first slinging worker WK1 in an easily understandable manner. Therefore, the slinging operation assistance system SYS can prevent the suspended load SL from being hoisted when the hook 7 is not located directly above the center-of-gravity position of the suspended load SL, and thus suppress swinging of the suspended load SL after being lifted off the ground.

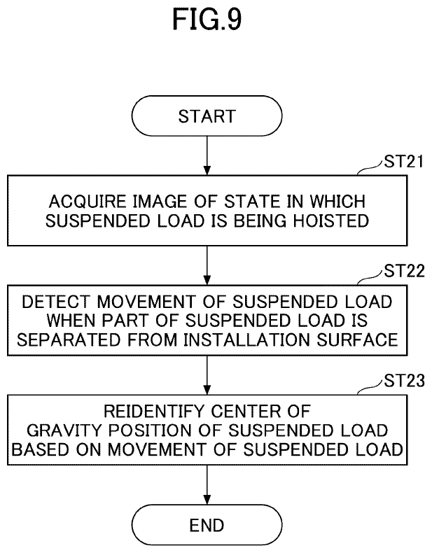

Next, another example of the center-of-gravity position reidentification processing will be described with reference to FIG. 9. FIG. 9 is a flowchart illustrating another example of a flow of the center-of-gravity position reidentification processing. The center-of-gravity position reidentification processing illustrated in FIG. 9 is different from the center-of-gravity position reidentification processing illustrated in FIG. 8 in that the center-of-gravity position of the suspended load SL is reidentified based on the movement of the suspended load SL when a part of the suspended load SL is separated from the installation surface IS before the suspended load SL is lifted off the ground. Other than that, the center-of-gravity position reidentification processing illustrated in FIG. 9 is the same as the center-of-gravity position reidentification processing illustrated in FIG. 8. Therefore, hereinafter, redundant description will be omitted, and the difference will be described in detail. Note that “when a part of the suspended load SL is separated from the installation surface IS” means, in other words, “when a different part of the suspended load SL is not yet separated from the installation surface IS.”

First, the client-side controller AU2 acquires a series of images of a state in which the suspended load SL is being hoisted (Step ST21), as in the center-of-gravity position reidentification processing illustrated in FIG. 8.

Thereafter, the client-side controller AU2 detects the movement of the suspended load SL when a part of the suspended load SL is separated from the installation surface IS (Step ST22). The movement of the suspended load SL includes inclination, translation, rotation, or the like of the suspended load SL. For example, based on the series of images captured by the second image-capturing device CM2, the client-side controller AU2 can detect that a lower-left-front corner portion of the suspended load SL having a substantially rectangular parallelepiped shape is lifted, and that the suspended load SL rotates counterclockwise about a vertical axis with a lower-right-rear corner portion of the suspended load SL serving as a rotation fulcrum.

Thereafter, the client-side controller AU2 reidentifies the center-of-gravity position of the suspended load SL based on the movement of the suspended load SL (Step ST23). For example, when the client-side controller AU2 determines that the suspended load SL has rotated counterclockwise about a vertical axis with the lower-right-rear corner portion of the suspended load SL serving as a rotation fulcrum, the client-side controller AU2 determines that the hook 7 is not located directly above the center-of-gravity position of the suspended load SL. Specifically, the client-side controller AU2 determines that the correct center-of-gravity position is located on the left rear side relative to the current incorrect center-of-gravity position. In this case, the client-side controller AU2 reidentifies the center-of-gravity position by moving the current incorrect center-of-gravity position further toward the left rear side.

In this case, the client-side controller AU2 may change, based on the reidentified center-of-gravity position, the display position of the operation assistance image SG (a graphic image indicating the position of the center of gravity of the suspended load SL) that is superimposed on the image of the suspended load SL.

The operator of the work machine 100 stops the raising of the hook 7 in response to an instruction from the slinging operation assistance system SYS or the first slinging worker WK1 and then lowers the hook 7 to the original target position.

Thereafter, the first slinging worker WK1 can give an instruction to the operator of the work machine 100 through the communication device TD or the like so as to move the hook 7 to a position directly above the reidentified center-of-gravity position. Note that the slinging operation assistance system SYS may automatically give substantially the same instruction to the operator of the work machine 100 independently of an instruction from the first slinging worker WK1.

By such center-of-gravity position reidentification processing, the slinging operation assistance system SYS can notify the first slinging worker WK1 that the hook 7 is not located directly above the position of the center of gravity of the suspended load SL. The slinging operation assistance system SYS can also present the reidentified center-of-gravity position to the first slinging worker WK1 in an easily understandable manner. Therefore, the slinging operation assistance system SYS can prevent the suspended load SL from being hoisted when the hook 7 is not located directly above the center-of-gravity position of the suspended load SL, and thus suppress swinging of the suspended load SL after being lifted off the ground.

In the example illustrated in FIG. 9, the client-side controller AU2 is configured to detect the movement of the suspended load SL based on the series of images captured by the second image-capturing device CM2. However, when a detection device that detects the position and the orientation of the hook 7 is provided at the hook 7, the client-side controller AU2 may be configured to detect the movement of suspended load SL based on an output from the detection device. Specifically, the client-side controller AU2 may receive data output from the detection device of the work machine 100 through the communication device TD or the like, and estimate the movement of the suspended load SL from the movement of the hook 7 detected based on the received data. Note that the detection device that detects the position and the orientation of the hook 7 is, for example, a global navigation satellite system (GNSS) compass, a gyro sensor, an acceleration sensor, or a combination thereof.

By such center-of-gravity position reidentification processing, the slinging operation assistance system SYS can determine, even after the center-of-gravity position of the suspended load SL in the ready state has been identified, whether or not the hook 7 is located directly above the position of the center of gravity of the suspended load SL when a part of the suspended load SL is separated from the installation surface. Therefore, even after the hoisting of the suspended load SL has been started, the slinging operation assistance system SYS can notify the first slinging worker WK1 that the hook 7 is not located directly above the position of the center of gravity of the suspended load SL. The slinging operation assistance system SYS can also present the reidentified center-of-gravity position to the first slinging worker WK1 in an easily understandable manner. Therefore, the slinging operation assistance system SYS can prevent the suspended load SL from being hoisted when the hook 7 is not located directly above the center-of-gravity position of the suspended load SL, and thus suppress swinging of the suspended load SL after being lifted off the ground.

As described above, the slinging operation assistance system SYS according to the embodiments of the present disclosure includes the image-capturing device CM that captures an image of the suspended load SL, the computing device AU that identifies the center-of-gravity position of the suspended load SL based on the captured image taken by the image-capturing device CM, and the output device that notifies the slinging worker WK of the center-of-gravity position of the suspended load SL identified by the computing device AU or the position of the hook for hoisting the suspended load SL, the position of the hook 7 being calculated based on the center-of-gravity position of the suspended load SL (e.g., see the hook 7T in FIG. 7). Note that the computing device AU is implemented by, for example, at least one of the work-machine-side controller AU1, the client-side controller AU2, or the server-side controller AU3. In the illustrated examples, the computing device AU is a client-side controller AU2. The image-capturing device CM that captures an image of the suspended load SL is, for example, at least one of the first image-capturing device CM1 attached to the work machine 100, the second image-capturing device CM2 mounted on the assistance device 200, the image-capturing device attached to a structure such as a steel tower at a work site, or the image-capturing device attached to a flying object such as a multicopter that flies over the suspended load SL. In the illustrated examples, the image-capturing device CM is the second image-capturing device CM2. The output device may be a laser emitting device, a projection device, a projector, or the like attached to the work machine 100 or to a structure such as a steel tower at a work site. In this case, for example, the laser emitting device serving as the display device DS may present the position of the center of gravity of the suspended load SL to the slinging worker WK by emitting a laser beam to one or more positions on the surface of the suspended load SL corresponding to the position of the center-of-gravity of the suspended load SL. The output device may be an audio output device such as a speaker that aurally notifies the slinging worker WK of various types of information, or may be a vibration generation device that tactually notifies the slinging worker WK of various types of information. The slinging operation assistance system SYS may be configured to generate an image, a sound, or a vibration in accordance with a distance between the position of the hook 7 and the position of the center of gravity of the suspended load SL (a distance on an imaginary plane parallel to the installation surface). For example, the slinging operation assistance system SYS may output an intermittent sound having a shorter output interval as the distance between the position of the hook 7 and the position of the center of gravity of the suspended load SL decreases.

This configuration can assist a slinging operation performed by the slinging worker WK by notifying the slinging worker WK of the information regarding the position of the center of gravity of the suspended load SL. This is because the slinging worker WK can thus hook the sling wire SW to the hook 7 positioned directly above the center of gravity of the suspended load SL. Therefore, this configuration provides an effect of suppressing swinging or falling of the suspended load SL during lifting off from the ground, as well as falling of the suspended load SL during conveyance. That is, this configuration provides an effect of appropriately performing a slinging operation without relying on the experience, skill, know-how, intuition, or the like of a skilled slinging worker. Moreover, the slinging worker WK can omit a complicated operation of repeatedly making fine adjustments to the position of the hook 7 relative to the suspended load SL while repeatedly lifting the suspended load SL by a small amount with the work machine 100. Therefore, this configuration provides an effect of reducing the burden on the slinging worker WK. This configuration also provides an effect of reducing the time required for a slinging operation performed by the slinging worker WK.

The output device may be the display device DS that displays the operation assistance image SG indicating the center-of-gravity position of the suspended load SL identified by the computing device AU or the position of the hook 7 (see the hook 7T in FIG. 7) for hoisting the suspended load SL, the position of the hook 7 being calculated based on the center-of-gravity position of the suspended load SL. In this case, the operation assistance image SG is displayed at a position visible to the slinging worker.

This configuration provides an effect of notifying the slinging worker WK of the position of the center of gravity of the suspended load SL in an easily understandable manner, as compared with a case where the slinging worker WK is notified of the position of the center of gravity of the suspended load SL aurally or tactually.

As illustrated in FIG. 4, the operation assistance image SG may be superimposed and displayed on the captured image taken by the image-capturing device CM. However, the operation assistance image SG may be an image displayed independently in a region different from the region where the image of the suspended load SL is displayed. In this case, the operation assistance image SG may be a combination of a computer graphic (CG) image representing the shape of the suspended load SL and an image representing the position of the center of gravity, which is superimposed and displayed on the CG image. Alternatively, the operation assistance image SG may be a text message such as “The center of gravity is located at a position 30 cm to the right, 50 cm downward, and 40 cm backward from the vertex on the upper-left front side of the suspended load SL.”

The configuration in which the operation assistance image SG is superimposed and displayed on the captured image taken by the image-capturing device CM provides an effect of notifying the slinging worker WK of the position of the center of gravity of the suspended load SL in an easily understandable manner, as compared with the configuration in which the operation assistance image is displayed in a region different from the region where the captured image is displayed.

The computing device AU is typically configured to identify the center-of-gravity position of the suspended load SL before the sling wire SW for hoisting the suspended load SL is hooked to the hook 7.

This configuration provides an effect of efficiently assisting a slinging operation performed by the slinging worker WK, as compared with a case where the center-of-gravity position of the suspended load SL is identified after the sling wire SW is hooked to the hook 7. This is because the frequency of re-hooking of the sling wire SW to the hook 7 can be reduced.

The image-capturing device CM may capture an image of a state in which the hook 7 is being raised while the plurality of sling wires SW for hoisting the suspended load SL are hooked to the hook 7. In this case, the computing device AU may detect a movement of at least one of the plurality of sling wires SW based on the captured image taken by the image-capturing device CM, in a state in which the hook 7 is raised while the plurality of sling wires SW are hooked to the hook 7. Then, the computing device AU may be configured to reidentify the center-of-gravity position of the suspended load SL based on the detected movement.

Therefore, this configuration provides an effect of more reliably suppressing swinging or falling of the suspended load SL during lifting off from the ground, as well as falling of the suspended load SL during conveyance. This is because it is possible to determine whether the hook 7 is located directly above the center-of-gravity position of the suspended load SL immediately before the suspended load SL is lifted off the ground, and to notify the slinging worker WK that the hook 7 is not located directly above the center-of-gravity position of the suspended load SL.

The image-capturing device CM may capture an image of a state in which a part of the suspended load SL is separated from the installation surface IS. In this case, the computing device AU may be configured to detect a movement of the suspended load SL, based on the captured image taken by the image-capturing device CM, at a time when a part of the suspended load SL is separated from the installation surface IS, and to reidentify the center-of-gravity position of the suspended load SL based on the movement. Note that this reidentification of the center-of-gravity position is desirably performed before the suspended load SL is lifted off the ground, that is, before the suspended load SL is separated from the installation surface IS. Then, when the computing device AU determines, based on the movement, that the hook 7 is not located directly above the center-of-gravity position of the suspended load SL, the computing device AU can stop the raising of the hook 7 and prompt a related person (the slinging worker WK or the operator of the work machine 100) to lower the suspended load SL onto the installation surface IS. The computing device AU can also prompt the related person to modify the position of the hook 7.

Therefore, this configuration provides an effect of further reliably suppressing swinging or falling of the suspended load SL during lifting off from the ground, as well as falling of the suspended load SL during conveyance. This is because it is possible to determine whether or not the hook 7 is located directly above the center-of-gravity position of the suspended load SL after a part of the suspended load SL is lifted but before the suspended load SL is lifted off the ground, and to notify the slinging worker WK that the hook 7 is not located directly above the center-of-gravity position of the suspended load SL.

The slinging operation assistance method for assisting a slinging operation for the suspended load SL according to an embodiment of the present disclosure includes a step of capturing, by the image-capturing device CM, an image of the suspended load SL, a step of identifying, by the computing device AU, the center-of-gravity position of the suspended load SL based on the captured image taken by the image-capturing device CM, and a step of notifying, by the output device, the slinging worker WK of the center-of-gravity position of the suspended load SL identified by the computing device AU or the position of the hook 7 for hoisting the suspended load SL, the position of the hook 7 being calculated based on the center-of-gravity position of the suspended load SL.

This method provides an effect of suppressing swinging or falling of the suspended load SL during lifting off from the ground, as well as falling of the suspended load SL during conveyance.

The slinging operation assistance program according to an embodiment of the present disclosure is a program causing a computer to execute a method for assisting a slinging operation for the suspended load SL, and the program causes the computer to execute: a step of capturing, by the image-capturing device CM, an image of the suspended load SL, a step of identifying, by the computing device AU, the center-of-gravity position of the suspended load SL based on the captured image taken by the image-capturing device CM, and a step of notifying, by the output device, the slinging worker WK of the center-of-gravity position of the suspended load SL identified by the computing device AU or the position of the hook 7 for hoisting the suspended load SL, the position of the hook 7 being calculated based on the center-of-gravity position of the suspended load SL.

This program provides an effect of suppressing swinging or falling of the suspended load SL during lifting off from the ground, as well as falling of the suspended load SL during conveyance.

In the above-described embodiment, the work machine 100 is a mobile crane, but may be a fixed crane. Alternatively, the work machine 100 may be an excavator having a crane function. That is, the work machine 100 may be an excavator provided with a hook accommodated at a rear side of the bucket. The slinging operation assistance system SYS may exclude at least one of the work machine 100 or the management device 300. For example, the slinging operation assistance system SYS may be configured by a combination of the assistance device 200 and the management device 300, may be configured by a combination of the work machine 100 and the assistance device 200, or may be configured by only the assistance device 200.

In the above-described embodiment, the slinging operation assistance system SYS is configured to assist a slinging operation in which the suspended load SL is hoisted by the hook 7 of the work machine 100. However, the slinging operation assistance system SYS may be configured to assist a slinging operation in which the suspended load SL is hoisted by using a chain block, such as a manual chain block or an electric chain block.

The preferred embodiments of the present invention have been described in detail above. However, the present invention is not limited to the above-described embodiments, and is not limited to embodiments described below. Various modifications, substitutions, and the like can be applied to the embodiments described above or below without departing from the scope of the present invention. In addition, the features described separately may be combined, provided that no technical inconsistency arises.

What is claimed is:

1. A slinging operation assistance system that assists a slinging operation for a suspended load, the system comprising:
an image-capturing device including a first memory and a first processor coupled to the first memory and configured to capture an image of the suspended load;
a computing device including a second memory and a second processor coupled to the second memory and configured to identify a center-of-gravity position of the suspended load based on the captured image taken by the image-capturing device; and
an output device including a third memory and a third processor coupled to the third memory and configured to notify a slinging worker of the center-of-gravity position of the suspended load identified by the computing device or a position of a hook for hoisting the suspended load, the position of the hook being calculated based on the center-of-gravity position of the suspended load.

2. The slinging operation assistance system according to claim 1, wherein
the third processor is further configured to display an operation assistance image indicating the center-of-gravity position of the suspended load or the position of the hook for hoisting the suspended load.

3. The slinging operation assistance system according to claim 2, wherein
the operation assistance image is superimposed and displayed on the captured image taken by the image-capturing device.

4. The slinging operation assistance system according to claim 1, wherein
the second processor is further configured to identify the center-of-gravity position of the suspended load before a sling wire for hoisting the suspended load is hooked to the hook.

5. The slinging operation assistance system according to claim 1, wherein
the first processor is further configured to capture an image of a state in which the hook is being raised while a plurality of sling wires for hoisting the suspended load are hooked to the hook, and
the second processor is further configured to reidentify the center-of-gravity position of the suspended load based on the captured image taken by the image-capturing device.

6. The slinging operation assistance system according to claim 1, wherein
the first processor is further configured to capture an image of a state in which a part of the suspended load is separated from an installation surface, and
the second processor is further configured to reidentify the center-of-gravity position of the suspended load based on the captured image taken by the image-capturing device.

7. A slinging operation assistance method that assists a slinging operation for a suspended load, the method comprising:
capturing, by an image-capturing device, an image of the suspended load;
identifying, by a computing device, a center-of-gravity position of the suspended load based on the captured image taken by the image-capturing device; and
notifying, by an output device, a slinging worker of the center-of-gravity position of the suspended load identified by the computing device or a position of a hook for hoisting the suspended load, the position of the hook being calculated based on the center-of-gravity position of the suspended load.

8. A computer readable medium storing a program that causes a computer to execute a process for assisting a slinging operation for a suspended load, the process comprising:
capturing, by an image-capturing device, an image of the suspended load;
identifying, by a computing device, a center-of-gravity position of the suspended load based on the captured image taken by the image-capturing device; and
notifying, by an output device, a slinging worker of the center-of-gravity position of the suspended load identified by the computing device or a position of a hook for hoisting the suspended load, the position of the hook being calculated based on the center-of-gravity position of the suspended load.
